(19) United States
(12) Patent Application Publication
(10) Pub. No.: US 2023/0024681 A1
(43) Pub. Date: Jan. 26, 2023

(54) Herb, Hemp, and Cannabis Film

(71) Applicant: Engineered Materials, Inc., Buffalo Grove, IL (US)

(72) Inventor: Keith W. Donaldson, Buffalo Grove, IL (US)

(21) Appl. No.: 17/944,646

(22) Filed: Sep. 14, 2022

Related U.S. Application Data
(63) Continuation of application No. 16/749,050, filed on Jan. 22, 2020.
(60) Provisional application No. 62/795,183, filed on Jan. 22, 2019.

(51) Int. Cl. B65D 81/24; A01N 59/20; B65D 65/38

(52) U.S. Cl. CPC B65D 81/24; A01N 59/20; B65D 65/38

(57) ABSTRACT

Polymer or polymer inks are used for reducing or eliminating harmful chemicals by offering a neutralizing chemical in the path of movement of the harmful chemicals. A neutralizing chemical responsive to the harmful chemical produces a harmless chemical as an output that is in the path of the harmful chemical and is opposite phase with the neutralizing chemical, preferably by 180 degrees, or is at least opposite in chemical compatibility to some extent. The neutralizing chemical can be suspended or combined with an inert carrier and preferably attenuates the harmful chemical concentration. The polymer ink can be applied to a media such as paper, (embossed or extruded) or polymer the same as paper but also in foam (open cell preferred) in order to obtain a decrease in the concentration of harmful gases. These forms can be utilized in air or liquid applications.

### RELATED APPLICATIONS

The present application claims the priority of U.S. Provisional Application Ser. No. 62/795,183 filed Jan. 22, 2019, and to U.S. Nonprovisional application Ser. No. 16/749,050 filed Jan. 22, 2020, both of which are fully incorporated herein by reference.

### FIELD OF THE INVENTION

The present inventions relate to a method and composition for neutralizing gases in the environment that speed up ripening of herbs and cannabis, and for neutralizing chemicals being given off by those items.

### BACKGROUND OF THE INVENTION

Various chemicals generate gases that can speed the degradation or ripening process of herbs and cannabis. Additionally, in the curing process for herbs and cannabis, often gases are emitted that can either speed the ripening (aging/degradation) process or can damage the materials if left in the packaging with the product. These gases coming from the curing process of cannabis and other herbs are nitrogen-based gases, among others. Additionally, mold and mildew readily can grow on these herbs, since they retain moisture.

The functionality, reliability, aesthetics, or useable life of the materials of interest are compromised by all of these. Previously, such materials have been enclosed in a covering with a type of coating to impede harmful chemical reactants such as atmospheric gaseous contaminants whether naturally occurring or man-made. These coatings are typically used to impede the harmful chemicals from reacting with the surfaces under protection by providing a barrier which relies on the polymer or other type of coating to utilize the permeation characteristics of the inert membrane of the protective media to provide the buffer between the harmful chemical and the surfaces under protection.

### SUMMARY OF THE INVENTION

In accordance with the present inventions, polymers or polymer based inks are provided that use an inert carrier to hold a neutralization chemical, preferably copper particles. The neutralizing chemicals use the chemistry and biological function of copper to inhibit mold and mildew, but by the selection of a high surface area copper particle, they can also be used to neutralize the gases in the environment that speed up ripening of herbs and cannabis, as well as to neutralize chemicals being given off by these items. The harmful chemicals can be in gaseous or liquid form. The inert carrier can be in sheet, foam, woven thread, mesh, extrusions, or other forms or shapes that offer a significant contact surface area to actual external area size or weight ratio. In preferred embodiments, the nitrogen-based gases being expelled from the herbs will react with copper particles in the packaging and be neutralized.

### DETAILED DESCRIPTION OF THE INVENTIONS AND THE PREFERRED EMBODIMENTS

Polymer or polymer inks are used for reducing or eliminating harmful chemicals by offering a neutralizing chemical in the path of movement of the harmful chemicals. A neutralizing chemical responsive to the harmful chemical produces a harmless chemical as an output that is in the path of the harmful chemical and is opposite phase with the neutralizing chemical, preferably by 180 degrees, or is at least opposite in chemical compatibility to some extent. The neutralizing chemical can be suspended or combined with an inert carrier and preferably attenuates the harmful chemical concentration. The polymer ink can be applied to a media such as paper, (embossed or extruded) or polymer the same as paper but also in foam (open cell preferred) in order to obtain a decrease in the concentration of harmful gases. These forms can be utilized in air or liquid applications. Uses can be as diverse as but not limited to interior cleansing of boxes, cartons, and containers to air conditioning moving air applications in dynamic environments.

In accordance with preferred embodiments of the present inventions packaging is provided for the protection of herbs and cannabis to provide protection against mold and mildew in the short term, and/or to provide shelf life extension and enhancement of the items packaged. Preferably, the herb and cannabis materials are packaged within copper-based films. Experimentation has shown both short term and long-term advantages gained from using this packaging technique and films.

According to the inventions, copper particles are suspended in a polymer that can then be made into films, laminates, thermoformed trays, or totes or injection-molded parts. Additionally, the copper polymer can be made into a coating that can be coated or printed onto paper or other substrates. The copper is bound in place, as testing has shown, but is available to prevent the growth of mold and mildew in contact with the film. Additionally, long-term storage shows the maintenance of key attributes of the items being stored in the films.

In a reactive embodiment, the copper can be physically or chemically suspended, coated, impressed into, or otherwise combined into, or on a material or surface to be protected or onto a carrier material, such as a paper or polymer sheet, and may be used as a wrapping or liner for the interior of an enclosure for the item to be protected. For open unenclosed environments, the items to be protected may have a favorable environment developed by the inventions by reducing the harmful chemicals in the air by attaching the ink to a filtration media comprised of a woven polymer, a paper, or a foam media. Alternatively, the copper can be an internal layer of a multi-layer film or material. This type of structure can hold multiple neutralization chemicals in separate layers to perform unique combinations of reactions to provide neutralization of multiple harmful reactive chemicals.

In accordance with the present inventions, by placing neutralizing chemicals in the path, the harmful chemicals must take to come in contact with the surfaces under protection. Thus, the protection afforded by the inventions offers orders of magnitude more protection than various prior methods. It should be noted that the reactants produced with the copper and the various gases preferably remains in the polymer or on the surface with the ink. The resultant chemicals are kept away from the items being protected.

The basis for the reactions follows the following rules:

Synthesis: A synthesis reaction is when two or more simple compounds combine to form a more complicated one. These reactions come in the general form of:

A+B→AB

One example of a synthesis reaction is the combination of copper and sulfur to form Copper (I) sulfide:

2Cu+S→Cu₂S

Likewise, there are many potential reactions with ozone and copper and nitrogen based chemicals (primarily ammonia) with copper:

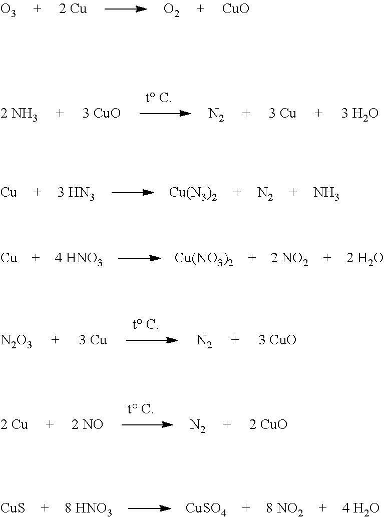

Any of these reactions can be used in accordance with the present invention.

Having described the inventions with respect to particular embodiments, it is to be understood that the description is not meant as a limitation, since numerous other modifications and variations may be made to the inventions or may suggest themselves. It is intended that the present inventions and application cover all such modifications and variations. Moreover, the information in each paragraph relates to and is intended to be used in conjunction with the inventions as disclosed in all other paragraphs herein and in conjunction with the information presented in the related applications.

What we claim is:

1. A method of preserving an herbal substance, wherein the herbal substance releases ammonia over time, the method comprising:
depositing the herbal substance in a closed container to limit air exposure and oxidation of the herbal substance, wherein the container includes copper particles; and
as the herbal substance naturally releases ammonia (NH₃) over time within the closed container, neutralizing the ammonia (NH₃) by reacting the copper particles with the released ammonia according to the equation: 2NH₃+3CuO→N₂+3Cu+3H₂O.

2. The method of claim 1, wherein the copper particles are coated onto a surface of the container.

3. The method of claim 1, wherein the copper particles are contained within an ink, and wherein the ink is applied to the container.

4. The method of claim 1, wherein the container is formed from a material including the copper particles.

5. The method of claim 1, wherein the copper particles are bound in place.

6. The method of claim 1, wherein the container includes at least a first layer and a second layer, and wherein the first and second layers include at least some of the copper particles.

7. The method of claim 1, wherein the reactants formed from neutralizing the ammonia remain on a surface of the container.

8. A method of preserving an herbal substance, wherein the herbal substance develops mold over time, the method comprising:
depositing the herbal substance in a closed container to limit air exposure and oxidation of the herbal substance, wherein the container includes copper particles that are configured to interact with the herbal substance when the herbal substance is deposited within the container; and
as the herbal substance naturally develops mold within the closed container, inhibiting the growth of the mold through the interaction of the copper particles with the herbal substance.

9. The method of claim 8, wherein the copper particles are coated onto a surface of the container.

10. The method of claim 8, wherein the copper particles are contained within an ink, and wherein the ink is applied to the container.

11. The method of claim 8, wherein the container is formed from a material including the copper particles.

12. The method of claim 88, wherein the copper particles are bound in place.

13. The method of claim 8, wherein the container includes at least a first layer and a second layer, and wherein the first and second layers include at least some of the copper particles.

14. A method of preserving an herbal substance, wherein the herbal substance releases ammonia and mold over time, the method comprising:
depositing the herbal substance in a closed container to limit air exposure and oxidation of the herbal substance, wherein the container includers copper particles;
as the herbal substance naturally releases ammonia (NH₃) over time within the closed container, neutralizing the ammonia (NH₃) by reacting the copper particles with the released ammonia according to the equation: 2NH₃+3CuO→N₂+3Cu+3H₂O; and
as the herbal substance naturally develops mold within the closed container, inhibiting the growth of the mold through the interaction of the copper particles with the herbal substance.

15. The method of claim 1414, wherein the copper particles are coated onto a surface of the container.

16. The method of claim 14, wherein the copper particles are contained within an ink, and wherein the ink is applied to the container.

17. The method of claim 14, wherein the container is formed from a material including the copper particles.

18. The method of claim 1414, wherein the copper particles are bound in place.

19. The method of claim 14, wherein the container includes at least a first layer and a second layer, and wherein the first and second layers include at least some of the copper particles.

20. The method of claim 14, wherein the reactants formed from neutralizing the ammonia remain on a surface of the container.
